(19) United States
(12) Patent Application Publication
(10) Pub. No.: US 2013/0076855 A1
(43) Pub. Date: Mar. 28, 2013

(54) IMAGE PROCESSING DEVICE CAPABLE OF GENERATING WIDE-RANGE IMAGE

(71) Applicant: Casio Computer Co., Ltd., Tokyo (JP)

(72) Inventors: Naotomo MIYAMOTO, Hamura-shi (JP); Kosuke MATSUMOTO, Hamura-shi (JP)

(73) Assignee: Casio Computer Co., Ltd., Tokyo (JP)

(21) Appl. No.: 13/626,150

(22) Filed: Sep. 25, 2012

(30) Foreign Application Priority Data
Sep. 26, 2011 (JP) 2011-209593

(51) Int. Cl. H04N 7/00

(52) U.S. Cl. 348/36; 348/E07.002

(57) ABSTRACT

The acquisition unit 52 acquires images. The estimation unit 53 estimates a specific position within a common region between the images acquired by the acquisition unit 52. The calculation unit 54 respectively calculates a difference value between the images within the common region, while shifting the specific position estimated by the estimation unit 53 in the predetermined direction within a predetermined range within the common region. The adjustment unit 57 adjusts the specific position based on the difference values between the images respectively calculated by the calculation unit 54. The generation unit 58 combines the images based on the specific position adjusted by the adjustment unit 57.

This application is based on and claims the benefit of priority from Japanese Patent Application No. 2011-209593, respectively filed on 26 Sep. 2011, the content of which is incorporated herein by reference.

### BACKGROUND OF THE INVENTION

1. Field of the Invention

The present invention relates to an image processing device capable of generating a wide-range image, an image processing method, and a recording medium.

2. Related Art

In digital cameras, portable telephones having an image capture function, and the like, the limit of the image capturing range depends on the hardware specifications provided by the device main body, such as the focal distance of the lens and size of the imaging elements.

Therefore, for cases of acquiring a wide-range image such that exceeds the hardware specification such as in panoramic photography, there is technology for continuous shooting while moving the image capturing device in a fixed direction, and generating a wide-range image by combining the plurality of obtained images.

In order to realize the aforementioned panoramic photography, a user moves so as to cause the digital camera to rotate horizontally about their body while keeping substantially fixed in the vertical direction, while maintaining a state making a pressing operation on the shutter switch, for example.

Thereupon, the digital camera generates the image data of a panoramic image by executing image capture processing a plurality of times in this period, and transversely (horizontally) combining the image data of the plurality of images each obtained as a result of image capture processing this plurality of times (hereinafter referred to as “captured image”).

Japanese Unexamined Patent Application, Publication No. H11-282100 discloses a method of generating the image data of a panoramic image by detecting a characteristic point in a captured image in each of a plurality of times of image capture processing, and transversely combining the image data of the plurality of captured images so that the characteristic points of two consecutively captured images match.

### SUMMARY OF THE INVENTION

An image processing device according to one aspect of the present invention includes: an acquisition unit that acquires images; an estimation unit that estimates a specific position within a common region between the images acquired by the acquisition unit; a first calculation unit that respectively calculates a difference value between the images within the common region, while shifting the specific position estimated by the estimation unit in the predetermined direction within a predetermined range within the common region; an adjustment unit that adjusts the specific position based on the difference values between the images respectively calculated by the first calculation unit; and a combination unit that combines the images based on the specific position adjusted by the adjustment unit.

In addition, in an image processing method according to one aspect of the present invention, the method includes the steps of: acquiring images; estimating a specific position within a common region between the images acquired by the acquisition unit; respectively calculating a difference value between the images within the common region, while shifting the specific position estimated in the step of estimating in the predetermined direction within a predetermined range within the common region; adjusting the specific position based on the difference values between the images respectively calculated in the step of calculating; and combining the images based on the specific position adjusted in the step of adjusting.

In addition, a recording medium according to one aspect of the present invention, encoded with a computer readable program for enabling a computer to function as: an acquisition unit that acquires images; an estimation unit that estimates a specific position within a common region between the images acquired by the acquisition unit; a calculation unit that respectively calculates a difference value between the images within the common region, while shifting the specific position estimated in the step of estimating in the predetermined direction within a predetermined range within the common region; an adjustment unit that adjusts the specific position based on the difference values between the images respectively calculated in the step of calculating; and a combination unit that combines the images based on the specific position adjusted in the step of adjusting

### BRIEF DESCRIPTION OF THE DRAWINGS

FIG. 1 is a block diagram showing a hardware configuration of a digital camera as one embodiment of an image processing device according to the present invention;

FIG. 2 is a functional block diagram showing a functional configuration for the digital camera of FIG. 1 to execute image capture processing;

FIG. 3 is a view illustrating image capture operations in cases of normal photography mode and panoramic photography mode being respectively selected as the operation mode of the digital camera of FIG. 2;

FIG. 4 is a view showing an example of a panoramic image generated according to the panoramic photography mode shown in FIG. 3;

FIG. 5 is a view illustrating a technique of the digital camera of FIG. 2 for estimating a combination position;

FIG. 6 is a view illustrating a technique of the digital camera of FIG. 2 for estimating a combination position;

FIG. 7 is a flowchart showing an example of the flow of image capture processing executed by the digital camera of FIG. 2;

FIG. 8 is a flowchart showing the detailed flow of panoramic image capture processing in the image capture processing of FIG. 7; and

FIG. 9 is a flowchart showing the detailed flow of panoramic combination processing in the panoramic image capture processing of FIG. 8.

### DETAILED DESCRIPTION OF THE INVENTION

Hereinafter, embodiments relating to the present invention will be explained while referencing the drawings.

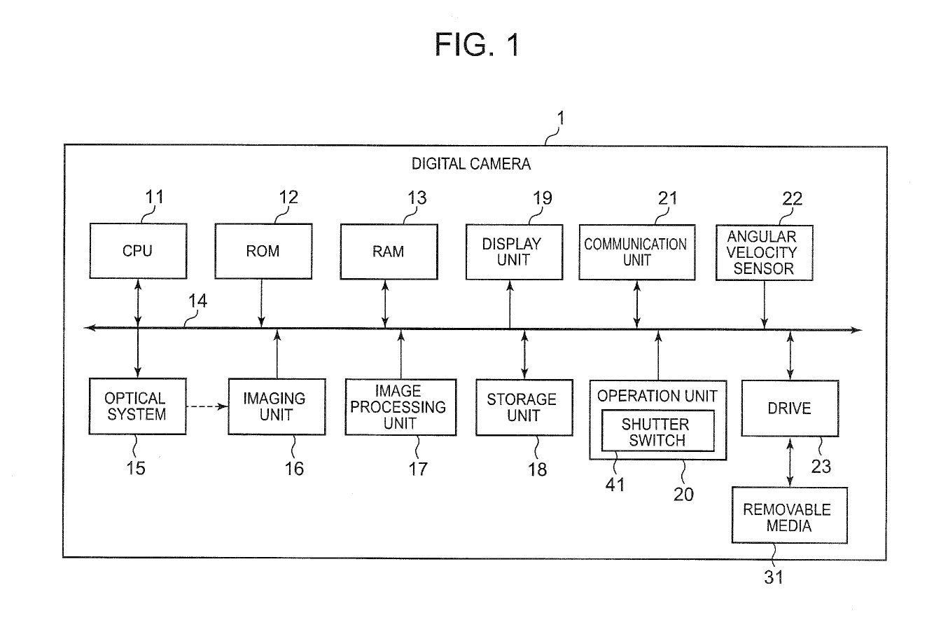

FIG. 1 is a block diagram showing the hardware configuration of a digital camera 1 as one embodiment of an image processing device according to the present invention.

The digital camera 1 includes a CPU (Central Processing Unit) 11, ROM (Read Only Memory) 12, RAM (Random Access Memory) 13, a bus 14, an optical system 15, an imaging unit 16, an image processing unit 17, a storage unit 18, a display unit 19, an operation unit 20, a communication unit 21, an angular velocity sensor 22, and a drive 23.

The CPU 11 executes various processing in accordance with programs stored in the ROM 12, or programs loaded from the storage unit 18 into the RAM 13.

The ROM 12 also stores the data and the like necessary upon the CPU 11 executing various processing.

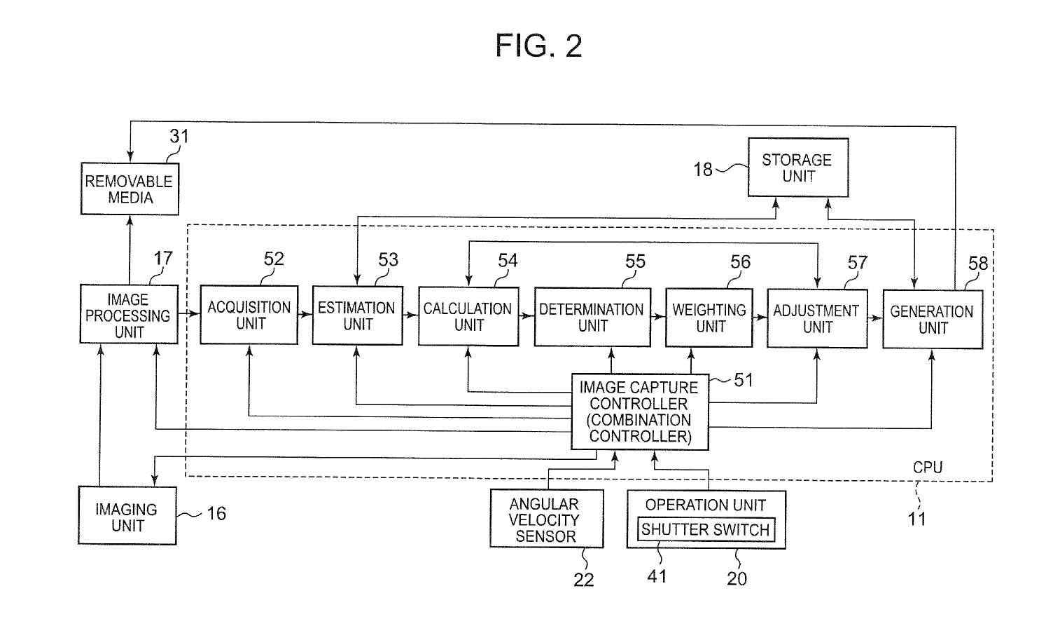

For example, programs for realizing the respective functions of an image capture controller 51 to a generation unit 58 in FIG. 2 described later are stored in the ROM 12 and storage unit 18 in the present embodiment. Therefore, the CPU 11 can realize the respective functions of the image capture controller 51 to the generation unit 58 in FIG. 2 described later, by executing the processing in accordance with these programs.

It should be noted that, it is also possible to assign at least a part of the respective functions of the image capture controller 51 to the generation unit 58 in FIG. 2 described later to the image processing unit 17.

The CPU 11, ROM 12 and RAM 13 are connected to each other via the bus 14. The optical system 15, the imaging unit 16, the image processing unit 17, the storage unit 18, the display unit 19, the operation unit 20, the communication unit 21, the angular velocity sensor 22 and the drive 23 are also connected to this bus 14.

The optical system 15 is configured by a lens that condenses light in order to capture an image of a subject, e.g., a focus lens, zoom lens, etc. The focus lens is a lens that causes a subject image to form on the light receiving surface of imaging elements of the imaging unit 16. The zoom lens is a lens that causes the focal length to freely change in a certain range. Peripheral devices that adjust the focus, exposure, etc. can also be provided to the optical system 15 as necessary.

The imaging unit 16 is configured from photoelectric conversion elements, AFE (Analog Front End), etc. The photoelectric conversion elements are configured from CCD (Charge Coupled Device) or CMOS (Complementary Metal Oxide Semiconductor)-type photoelectric conversion elements. Every fixed time period, the photoelectric conversion elements photoelectrically convert (capture) an optical signal of an incident and accumulated subject image during this period, and sequentially supply the analog electric signals obtained as a result thereof to the AFE.

The AFE conducts various signal processing such as A/D (Analog/Digital) conversion processing on these analog electric signals, and outputs the digital signals obtained as a result thereof as output signals of the imaging unit 16.

It should be noted that the output signal of the imaging unit 16 will be referred to as “image data of captured image” hereinafter. Therefore, the image data of the captured image is outputted from the imaging unit 16, and supplied as appropriate to the image processing unit 17, etc.

The image processing unit 17 is configured from a DSP (Digital Signal Processor), VRAM (Video Random Access Memory), etc.

The image processing unit 17 conducts image processing such as noise reduction, white balance and image stabilization on the image data of a captured image input from the imaging unit 16, in cooperation with the CPU 11.

Herein, unless otherwise noted, “image data” hereinafter refers to image data of a captured image input from the imaging unit 16 every fixed time period, or data in which this image data has been processed or the like. In other words, in the present embodiment, this image data is adopted as a unit of processing.

The storage unit 18 is configured by DRAM (Dynamic Random Access Memory), etc., and temporarily stores image data outputted from the image processing unit 17, image data of a panoramic intermediate image described later, and the like. In addition, the storage unit 18 also stores various data and the like required in various image processing.

The display unit 19 is configured as a flat display panel consisting of an LCD (Liquid Crystal Device) and LCD driver, for example. The display unit 19 displays images representative of the image data supplied from the storage unit 18 or the like, e.g., a live-view image described later, in a unit of image data.

Although not illustrated, the operation unit 20 has a plurality of switches in addition to a shutter switch 41, such as a power switch, photography mode switch and playback switch. When a predetermined switch among this plurality of switches is subjected to a pressing operation, the operation unit 20 supplies a command assigned for the predetermined switch to the CPU 11.

The communication unit 21 controls communication with other devices (not illustrated) via a network including the Internet.

The angular velocity sensor 22 consists of a gyro or the like, detects the amount of angular displacement of the digital camera 1, and provides a digital signal (hereinafter referred to simply as “amount of angular displacement”) indicating the detection result to the CPU 11. It should be noted that the angular velocity sensor 22 is established to also exhibit the function of a direction sensor as necessary.

A removable media 31 made from a magnetic disk, optical disk, magneto-optical disk, semiconductor memory, or the like is installed in the drive 23 as appropriate. Then, programs read from the removable media 31 are installed in the storage unit 18 as necessary. In addition, similarly to the storage unit 18, the removable media 31 can also store various data such as the image data stored in the storage unit 18.

FIG. 2 is a functional block diagram showing a functional configuration for executing a sequence of processing (hereinafter referred to as “image capture processing”), in the processing executed by the digital camera 1 of FIG. 1, from capturing an image of a subject until recording image data of the captured image obtained as a result thereof in the removable media 31.

As shown in FIG. 2, the CPU 11 includes the image capture controller 51, an acquisition unit 52, an estimation unit 53, a calculation unit 54, a determination unit 55, a weighting unit 56, an adjustment unit 57, and the generation unit 58.

It should be noted that the respective functions of the image capture controller 51 to the generation unit 58 as described above do not necessarily have to be built into the CPU as in the present embodiment, and it is also possible to assign at least a part of these respective functions to the image processing unit 17.

The image capture controller 51 controls the overall execution of image capture processing. For example, the image capture controller 51 can selectively switch between a normal photography mode and a panoramic photography mode as the operation modes of the digital camera 1, and execute processing in the accordance with the switched operation mode.

When in the panoramic photography mode, the acquisition unit 52 to the generation unit 58 operate under the control of the image capture controller 51.

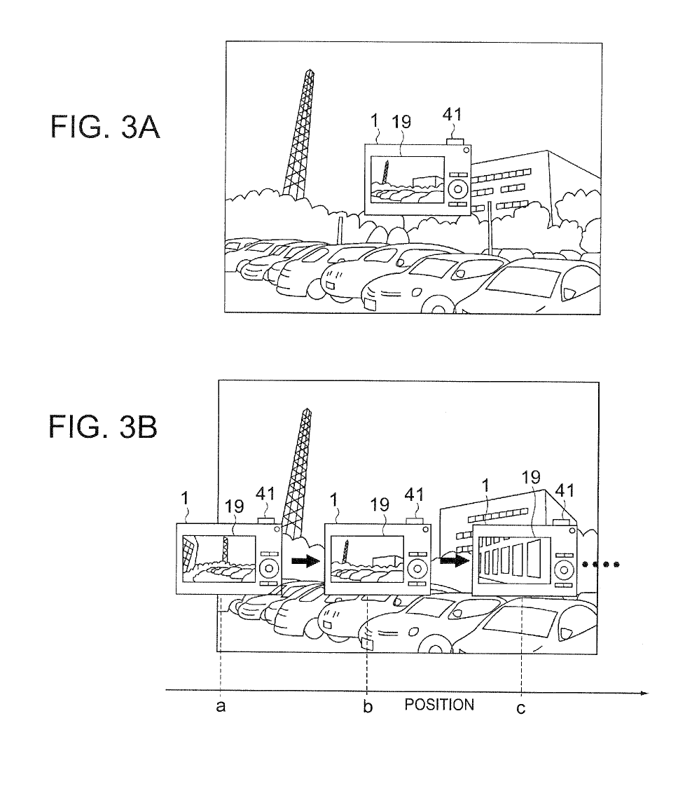

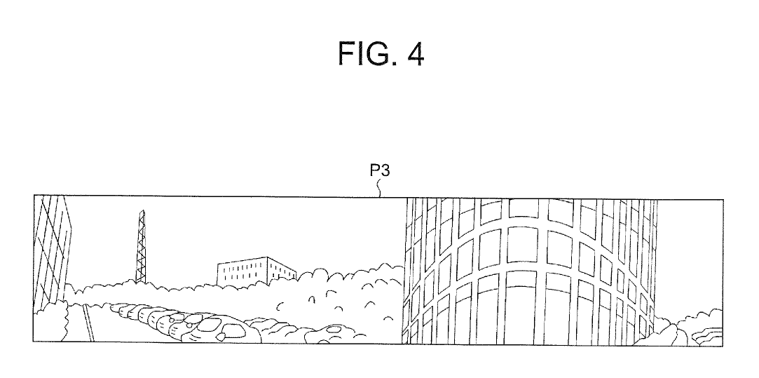

Herein, in order to facilitate understanding of the image capture controller 51 to the generation unit 58, prior to explanation of these functional configurations, the panoramic photography mode will be explained in detail while referencing FIGS. 3 and 4 as appropriate.

FIG. 3 is a view illustrating image capture operations in cases of normal photography mode and panoramic photography mode being respectively selected as the operation mode of the digital camera 1 of FIG. 1.

In detail, FIG. 3A is a view illustrating the image capture operation in the normal photography mode. FIG. 3B is a view illustrating the image capture operation in the panoramic photography mode.

In each of FIGS. 3A and 3B, the picture that is inside of the digital camera 1 indicates the appearance of the real world including the subject of the digital camera 1. In addition, the vertical dotted lines shown in FIG. 3B indicate the respective positions a, b and c in a movement direction of the digital camera 1. The movement direction of the digital camera 1 refers to the direction in which the optical axis of the digital camera 1 moves when the user causes the image capture direction (angle) of the digital camera 1 to change about their body.

The normal photography mode refers to an operation mode when capturing an image of a size (resolution) corresponding to the angle of view of the digital camera 1.

In the normal photography mode, the user presses the shutter switch 41 of the operation unit 20 to the lower limit while making the digital camera 1 stationary, as shown in FIG. 3A. It should be noted that the operation to press the shutter switch 41 to the lower limit will hereinafter be referred to as “full press operation” or simply “fully press”.

The image capture controller 51 controls execution of a sequence of processing immediately after a full press operation has been made until causing image data outputted from the image processing unit 17 to be recorded in the removable media 31 as a recording target.

Hereinafter, the sequence of processing executed according to the control of the image capture controller 51 in the normal photography mode is referred to as “normal image capture processing”.

On the other hand, panoramic photography mode refers to an operation mode in a case of capturing a panoramic image.

As shown in FIG. 3B, in the panoramic photography mode, the user causes the digital camera 1 to move in the direction of the black arrow in the same figure, while maintaining the full press operation of the shutter switch 41.

The image capture controller 51 controls the acquisition unit 52 to the generation unit 58 while the full press operation is maintained, and every time the amount of angular displacement from the angular velocity sensor 22 reaches a fixed value, immediately thereafter repeats temporarily storing image data output from the image processing unit 17 in the storage unit 18.

Subsequently, the user instructs the end of panoramic image capture by making an operation to release the full press operation, i.e. an operation to distance a finger or the like from the shutter switch 41 (hereinafter such an operation is referred to as “release operation”).

The image capture controller 51 controls the acquisition unit 52 to the generation unit 58, and when the end of panoramic photography is instructed, generates image data of a panoramic image by combining the plurality of image data sets thus far stored in the storage unit 18 in the horizontal direction in the order of being stored.

Then, the image capture controller 51 controls the acquisition unit 52 to the generation unit 58, and causes the image data of the panoramic image to be recorded in the removable media 31 as a recording target.

In this way, the image capture controller 51 controls the acquisition unit 52 to the generation unit 58 in the panoramic photography mode to control the sequence of processing from generating the image data of a panoramic image until causing this to be recorded in the removable media 31 as a recording target.

Hereinafter, the sequence of processing executed according to the control of the image capture controller 51 in the panoramic photography mode in this way will be referred to as “panoramic image capture processing”.

FIG. 4 shows image data of a panoramic image generated by the acquisition unit 52 to the generation unit 58 in the panoramic photography mode shown in FIG. 3.

In other words, in the panoramic photography mode, when an image capture operation such as that shown in FIG. 3 is performed, image data of a panoramic image P3 such as that shown in FIG. 4 is generated by the acquisition unit 52 to the generation unit 58, and is recorded in the removable media 31, under the control of the image capture controller 51.

The acquisition unit 52 to the generation unit 58 execute the following such processing under the control of the image capture controller 51.

The acquisition unit 52 receives an acquisition command issued from the image capture controller 51 every time the digital camera 1 moves by a predetermined amount (every time the amount of angular displacement reaches a fixed value), and sequentially acquires image data of successively captured images from the image processing unit 17.

The estimation unit 53 estimates, in a case of combining consecutive image data in a spatial direction for the respective image data sequentially acquired by the acquisition unit 52, the combination position at which to combine within each region contacting or overlapping with consecutive image data (hereinafter referred to as “combination portion”). Herein, consecutive image data refers to the image data of a captured image obtained by image capturing a K^{th} time (K being a positive integer equal to or more than 1) during panoramic image capture, and the image data of a captured image obtained by image capture a K+1^{th} time in the same panoramic image capture.

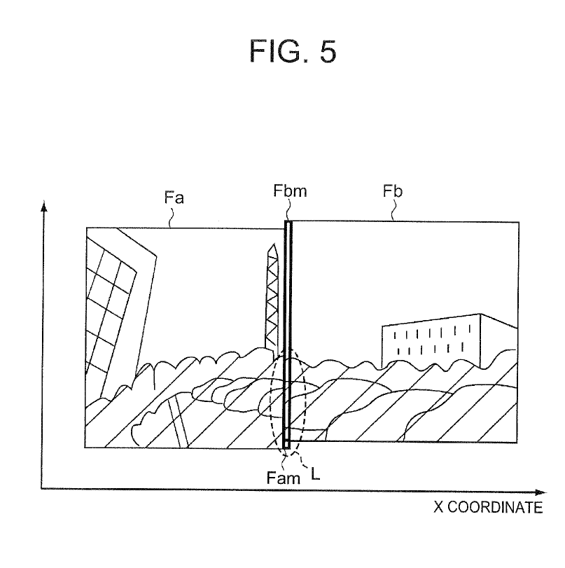

FIG. 5 is a view illustrating a technique of the estimation unit 53 estimating a combination position.

In FIG. 5, the image data Fa indicates image data of the above-mentioned K^{th} time. The image data Fb indicates image data of the above-mentioned K+1^{th} time. In other words, the image data Fb is obtained the subsequent time to the image data Fa being obtained.

In FIG. 5, the portion hatched with slanted lines indicates the luminance being low compared to other portions.

As shown in FIG. 5, the estimation unit 53 detects the respective combination portions Fam, Fbm in which the image data Fa and image data Fb overlap, and estimates the combination position within an overlapping region of the combination portions Fam, Fbm.

Herein, the combination portion becomes an aggregate of pixels constituting a line or rectangle among the respective pixels constituting the image data sets. Herein, the longer direction of the combination portion is referred to as “length direction”, and the direction orthogonal to the length direction is referred to as “width direction”. In the present embodiment, a plurality of image data sets is combined in the horizontal direction (X coordinate direction in FIG. 5); therefore, the length direction of the combination portion is defined as the vertical direction (Y coordinate direction in FIG. 5), and the width direction of the combination portion is defined as the horizontal direction (X coordinate direction in FIG. 5). In addition, although the length in the width direction of the combination portions Fam, Fbm is set to 3 dots in the present embodiment, it is not limited thereto, and can be set to any length.

Herein, the detection technique for the combination portions Fam, Fbm is not particularly limited, and any technique such as a technique that compares the image data Fa and image data Fb by image processing can be employed.

However, in the present embodiment, acquisition of image data is performed one time every time the digital camera 1 moves by a predetermined amount (every time the amount of angular displacement reaches a fixed value), as described above. Therefore, the combination portions Fam, Fbm can be estimated based on this predetermined amount (fixed value for the amount of angular displacement). Therefore, the technique for setting the portion estimated based on this predetermined amount (fixed value for the amount of angular displacement) as the combination portions Fam, Fbm is employed in the present embodiment.

Then, the estimation unit 53 estimates the combination position within the overlapping region Fab by calculating the motion vector of a characteristic point (pixel) in each of the combination portions Fam, Fbm, according to the corner detection method of Harris or the like in the present embodiment.

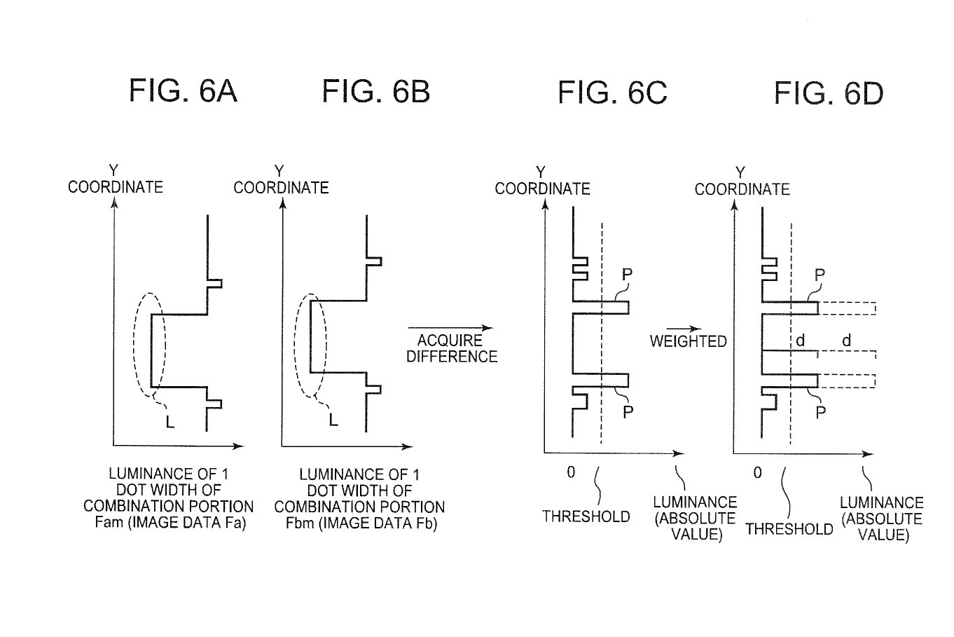

FIG. 6 is a view illustrating a technique of the estimation unit 53 estimating the combination position.

The calculation unit 54 calculates a difference in the luminance of pixels between image data within the overlapping region Fab, while shifting the estimated combination position in the vertical direction that is a predetermined direction in the combination portions Fam, Fbm, which are within a predetermined region.

FIG. 6A shows the luminance value of a portion of 1 dot width, in the combination portion Fam within the image data Fa in FIG. 5.

FIG. 6B shows the luminance value of a portion of 1 dot width, in the combination portion Fbm within the image data Fb in FIG. 5

In FIGS. 6A and B, the Y coordinate is the same as that of FIG. 5, and indicates the vertical direction of image data.

From FIGS. 6A and B, the luminance value of a portion L enclosed by the dotted line in FIG. 5 is found to be low compared to other portions in FIG. 5.

FIG. 6C shows the absolute value of the difference (hereinafter referred to as “pixel value difference”) between the luminance value of a column of 1 dot width in the combination portion Fam in FIG. 6A and the luminance value of a column of 1 dot width in the combination portion Fbm in FIG. 6B corresponding to a position of 1 dot width in the combination portion Fam, calculated by the calculation unit 54.

The determination unit 55 determines whether or not the pixel value difference calculated by the calculation unit 54 is equal to or more than a threshold (dotted line in FIG. 6), and extracts portions P in which the pixel value difference is equal to or more than the threshold.

FIG. 6D shows the pixel value difference weighted in the portions P in FIG. 5.

The weighting unit 56 carries out weighting on the portions P for which it is determined by the determination unit 55 that the pixel value difference is equal to or more than the threshold. More specifically, the weighting unit 56 carries out weighting so as to double the pixel value difference d of the portions P. Upon calculating the sum of pixel value differences in the overlapping region Fab (Sum of Absolute Difference; hereinafter referred to as “SAD”), the weighting unit 56 calculates a SAD in which the pixel value differences constituting the value of this SAD are weighted (hereinafter also referred to as “weighted SAD”).

It should be noted that, although SAD is employed as the technique for calculating the degree of similarity of two sets of image data in the combination portion in the present embodiment, it is not particularly limited thereto, and the sum of squared difference or the like can be employed, for example.

In addition, although the luminance value is employed as the pixel value for calculating the degree of similarity of two sets of image data in the combination portion in the present embodiment, it is not particularly limited thereto, and the color difference or hue can also be employed.

According to the above technique, with the combination position estimated by the estimation unit 53 as the basis, the calculation unit 54 calculates the pixel value difference in the overlapping region Fab in 16 ways (up and down total in 32 ways), while shifting in 1 dot increments the combination portions Fam, Fbm in the up/down direction (Y coordinate direction in FIGS. 5 and 6), with an interval of a predetermined number of dots (e.g., 1 dot).

The weighting unit 56 weights the portions P having a pixel value difference equal to or more than the threshold, based on the determination results of the determination unit 55, and then calculates the weighted SAD in 32 ways.

In this way, the weighted SAD can be calculated in a wider range in the up/down direction of the combination portion, by respectively calculating the pixel value differences for the overlapping region Fab with an interval of a predetermined number of dots.

Among the values of weighted SAD calculated by the weighting unit 56, the adjustment unit 57 adjusts the position of the image data corresponding to the smallest weighted SAD value as a combination position candidate.

Then, by the aforementioned method, the calculation unit 54 further calculates the SAD in 16 ways (up and down total in 32 ways), while shifting the combination portions Fam, Fbm in 1 dot increments in the up/down direction (Y coordinate direction in FIGS. 5 and 6), with the combination position candidate adjusted by the adjustment unit 57 as a basis.

Then, the weighting unit 56 calculates the weighted SAD by the aforementioned weighting method in 32 ways.

Among the values of weighted SAD in 32 ways weighted by the weighting unit 56, the adjustment unit 57 adjusts the position corresponding to the smallest weighted SAD value becomes the combination position.

The calculation unit 54 in this way comes to calculate the pixel value difference two times. In other words, as a first time, the calculation unit calculates the pixel value difference while shifting in 1 dot increments with an interval of a predetermined number of dots, and as a second time, calculates the pixel value difference while shifting in 1 dot increments without the interval of a predetermined number of dots. Since the first time can thereby calculate the pixel value difference in a wider range in the up/down direction of the combination portion, it refines the combination position to a probable position to some extent, and the second time can adjust to a more accurate combination position by calculating the pixel value difference in detail with the refined position as a basis.

In addition, although the SAD is calculated while shifting by a predetermined number of dots in the up/down direction for everywhere within the overlapping region Fab of the combination portions Fam, Fbm in the present embodiment, it may be configured so as to calculate the SAD for a portion of the range of the overlapping region Fab. In other words, while calculating SAD, it may be configured so as to keep the number of dots of the overlapping region for calculating SAD constant, by leaving a region with the maximum number of dots shifted in the up/down direction (in a process calculating SAD while shifting by a predetermined number of dots, regions in which the combination portions Fam, Fbm no longer overlap) out from the calculation candidates for SAD in advance.

By configuring in this way, the estimation/adjustment of the combination position at which SAD is a minimum becomes more accurate.

In accordance with the control of the image capture controller 51, the generation unit 58 combines consecutive image data based on the combination position adjusted by the adjustment unit 57, and generates the image data of a panoramic image.

The acquisition unit 52 to the generation unit 58 generate the image data of a panoramic image by combining a plurality of image data sets acquired thus far by the above processing, in the horizontal direction in the order stored.

The functional configuration of the digital camera 1 to which the present invention is applied has been explained in the foregoing while referencing FIGS. 2 to 6.

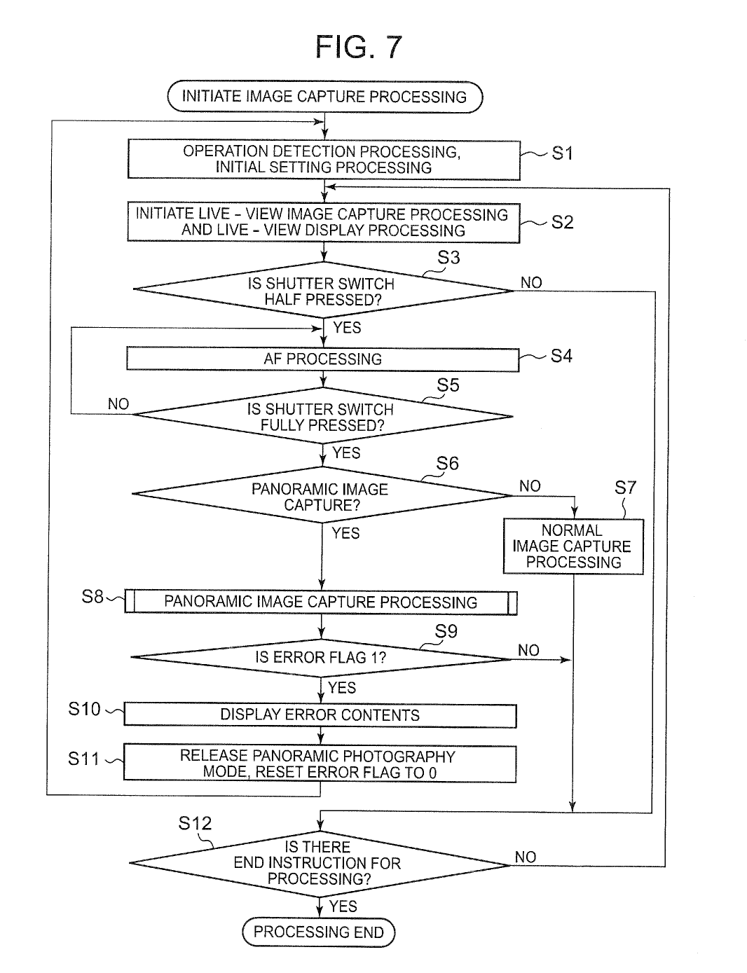

Next, image capture processing executed by the digital camera 1 having such a functional configuration will be explained while referencing FIG. 7.

FIG. 7 is a flowchart showing an example of the flow of image capture processing.

In the present embodiment, image capture processing starts when a power source (not illustrated) of the digital camera 1 is turned ON.

In Step S1, the image capture controller 51 of FIG. 2 executes operation detection processing and initial setting processing.

The operation detection processing refers to processing to detect the state of each switch in the operation unit 20. The image capture controller 51 can detect if the normal photography mode is set as the operation mode, or if the panoramic photography mode is set, by executing operation detection processing.

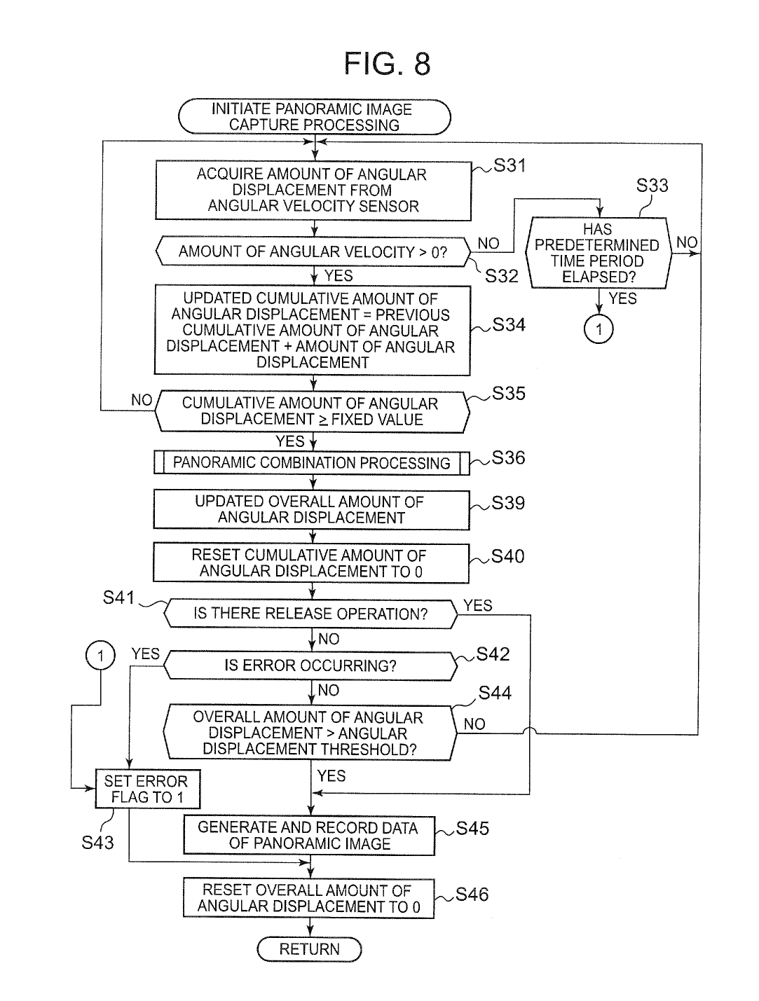

In addition, as one type of initial setting processing of the present embodiment, processing is employed to set a fixed value of the amount of angular displacement and an angular displacement threshold (e.g., 360°), which is the maximum for the amount of angular displacement. More specifically, the fixed value for the amount of angular displacement and the angular displacement threshold (e.g., 360°) that is the maximum for the amount of angular displacement are stored in advanced in the ROM 12 of FIG. 1, and are set by reading from the ROM 12 and writing to the RAM 13. It should be noted that the fixed value for the amount of angular displacement is used in the determination processing of Step S35 in FIG. 8 described later. On the other hand, the angular displacement threshold (e.g., 360°) that is the maximum for the amount of angular displacement is used in the determination processing of Step S44 in FIG. 8.

In addition, as shown in Steps S34, S39, etc. of FIG. 8 described later, the amount of angular displacement detected by the angular velocity sensor 22 is cumulatively added, and the cumulative amount of angular displacement serving as a cumulative additive value thereof and overall amount of angular displacement (the difference between the two will be explained later) are stored in the RAM 13. Therefore, processing to reset this cumulative amount of angular displacement and overall amount of angular displacement to 0 is employed as one type of initial setting processing in the present embodiment. It should be noted that the cumulative amount of angular displacement is compared with the aforementioned fixed value in the determination processing of Step S35 in FIG. 8 described later. On the other hand, the overall amount of angular displacement is compared with the aforementioned angular displacement threshold in the determination processing of Step S44 in FIG. 8 described later.

Furthermore, the processing to reset an error flag to 0 is employed as one type of initial setting processing of the present invention. The error flag refers to a flag set to 1 when an error occurs during panoramic image capture processing (refer to Step S43 in FIG. 8 described later).

In Step S2, the image capture controller 51 starts live-view image capture processing and live-view display processing.

In other words, the image capture controller 51 controls the imaging unit 16 and the image processing unit 17 to cause the image capture operation to continue by the imaging unit 16. Then, while the image capture operation is being continued by the imaging unit 16, the image capture controller 51 causes the image data sequentially outputted from the image processing unit 17 via the imaging unit 16 to be temporarily stored in memory (in the present embodiment, the storage unit 18). Such a sequence of control processing by the image capture controller 51 is herein referred to as “live-view image capture processing”.

In addition, the image capture controller 51 sequentially reads the respective image data sets temporarily recorded in the memory (in the present embodiment, the storage unit 18) during live-view image capture, and causes images respectively corresponding to the image data to be sequentially displayed on the display unit 19. Such a sequence of control processing by the image capture controller 51 is referred to herein as “live-view display processing”. It should be noted that the images being sequentially displayed on the display unit 19 according to the live-view display processing are referred to as “live-view images”.

In Step S3, the image capture controller 51 determines whether or not the shutter switch 41 has been half pressed.

Herein, half press refers to an operation depressing the shutter switch 41 of the operation unit 20 midway (a predetermined position short of the lower limit), and hereinafter is also called “half press operation” as appropriate.

In a case of the shutter switch 41 not being half pressed, it is determined as NO in Step S3, and the processing advances to Step S12.

In Step S12, the image capture controller 51 determines whether or not an end instruction for processing has been made.

Although the end instruction for processing is not particularly limited, in the present embodiment, the notification of the event of the power source (not illustrated) of the digital camera 1 having entered an OFF state is adopted thereas.

Therefore, in the present embodiment, when the power source enters the OFF state and such an event is notified to the image capture controller 51, it is determined as YES in Step S12, and the overall image capture processing comes to an end.

In contrast, in the case of the power source being in an ON state, since notification of the event of the power source having entered the OFF state is not made, it is determined as NO in Step S12, the processing is returned to Step S2, and this and following processing is repeated. In other words, in the present embodiment, so long as the power source maintains the ON state, in a period until the shutter switch 41 is half pressed, the loop processing of Step S3: NO and Step S12:NO is repeatedly executed, whereby the image capture processing enters a standby state.

During this live-view display processing, if the shutter switch 41 is half pressed, it is determined as YES in Step S3, and the processing advances to Step S4.

In Step S4, the image capture controller 51 executes so-called AF (Auto Focus) processing by controlling the imaging unit 16.

In Step S5, the image capture controller 51 determines whether or not the shutter switch 41 is fully pressed.

In the case of the shutter switch 41 not being fully pressed, it is determined as NO in Step S5. In this case, the processing is returned to Step S4, and this and following processing is repeated. In other words, in the present embodiment, in a period until the shutter switch 41 is fully pressed, the loop processing of Step S4 and Step S5:NO is repeatedly executed, and the AF processing is executed each time.

Thereafter, when the shutter switch 41 is fully pressed, it is determined as YES in Step S5, and the processing advances to Step S6.

In Step S6, the image capture controller 51 determines whether or not the photography mode presently set is the panoramic photography mode.

In the case of not being the panoramic photography mode, i.e. in a case of the normal photography mode presently being set, it is determined as NO in Step S6, and the processing advances to Step S7.

In Step S7, the image capture controller 51 executes the aforementioned normal image capture processing.

In other words, one image data set outputted from the image processing unit 17 immediately after a full press operation was made is recorded in the removable media 31 as the recording target. The normal image capture processing of Step S7 thereby ends, and the processing advances to Step S12. It should be noted that, since the processing of Step S12 and after have been described in the foregoing, an explanation thereof will be omitted herein.

In contrast, in the case of the panoramic photography mode being presently set, it is determined as YES in Step S6, and the processing advances to Step S8.

In Step S8, the image capture controller 51 executes the aforementioned panoramic image capture processing.

Although the details of panoramic photography processing are described later while referencing FIG. 8, as a general rule, the image data of a panoramic image is generated, and then recorded in the removable media 31 as a recording target. The panoramic image capture processing of Step S8 thereby ends, and the processing advances to Step S9.

In Step S9, the image capture controller 51 determines whether or not the error flag is 1.

Although the details are described later while referencing FIG. 8, the image data of the panoramic image is recorded in the removable media 31 as a recording target, and if the panoramic image capture processing of Step S8 properly ends, the error flag will be 0. In such a case, it is determined as NO in Step S9, and the processing advances to Step S12. It should be noted that the processing of Step S12 and after has been described above; therefore, an explanation thereof will be omitted herein.

Contrarily, if any error occurs during the panoramic image capture processing of Step S8, the panoramic photography processing will end improperly. In such a case, since the error flag will be 1, it is determined as YES in Step S9, and the processing advances to Step S10.

In Step S10, the image capture controller 51 displays error contents on the display unit 19. A specific example of the error contents displayed will be described later.

In Step S11, the image capture controller 51 cancels the panoramic photography mode, and resets the error flag to 0.

Subsequently, the processing is returned to Step S1, and this and following processing is repeated. In other words, the image capture controller 51 establishes a subsequent new image capture operation by the user.

The flow of image capture processing has been explained in the foregoing while referencing FIG. 7.

Next, the detailed flow of panoramic image capture processing of Step S8 in the image capture processing of FIG. 7 will be explained while referencing FIG. 8.

FIG. 8 is a flowchart illustrating the detailed flow of panoramic image capture processing.

As described in the foregoing, when the shutter switch 41 is fully pressed in the state of the panoramic photography mode, it is determined as YES in Steps S5 and S6 in FIG. 7, the processing advances to Step S8, and the following processing is executed as the panoramic image capture processing.

In other words, in Step S31 of FIG. 8, the image capture controller 51 acquires the amount of angular displacement from the angular velocity sensor 22.

In Step S32, the image capture controller 51 determines whether or not the amount of angular displacement acquired in the processing of Step S31 is greater than 0.

Since the amount of angular displacement is 0 while the user is not causing the digital camera 1 to move, it is determined as NO in Step S32, and the processing advances to Step S33.

In Step S33, the image capture controller 51 determines whether or not the continuation of the amount of angular displacement being 0 has elapsed for a predetermined time. As the predetermined time, for example, a suitable time can be employed that is longer than a required time after the user fully presses the shutter switch 41 until initiating movement of the digital camera 1.

In a case of the predetermined time not having elapsed, it is determined as NO in Step S33, the processing is returned to Step S31, and this and following processing is repeated. In other words, in a case of the continuation time of a state of the user not causing the digital camera 1 to move being shorter than the predetermined time, the image capture controller 51 will set the panoramic image capture processing to a standby state by repeatedly executing loop processing of Step S31 to Step S33:NO.

If the user causes the digital camera 1 to move during this standby state, the amount of angular displacement acquired from the angular velocity sensor 22 will be a value greater than 0. In such a case, it is determined as YES in Step S32, and the processing advances to Step S34.

In Step S34, the image capture controller 51 updates the cumulative amount of angular displacement by adding the amount of angular displacement acquired in the processing of Step S31 to the past cumulative amount of angular displacement (updated cumulative amount of angular displacement=past cumulative amount of angular displacement+amount of angular displacement). In other words, the value stored as the cumulative amount of angular displacement in the RAM 13 is updated.

Cumulative amount of angular displacement is a value arrived at by cumulatively adding the amount of angular displacement in this way, and indicates a movement amount of the digital camera 1.

Herein, in the present embodiment, one set of image data (combination target) for the image data generation of a panoramic intermediate image is supplied from the image processing unit 17 to the acquisition unit 52, when the user causes the digital camera 1 to move by a fixed amount.

To realize this, the cumulative amount of angular displacement corresponding to the “fixed amount” of the movement amount of the digital camera 1 is provided in advance as a “fixed value” from the initial setting processing of Step S1 in FIG. 7.

In other words, in the present embodiment, every time the cumulative amount of angular displacement reaches a fixed value, one set of image data (combination target) is supplied from the image processing unit 17 to the acquisition unit 52, and the cumulative amount of angular displacement is reset to 0.

Such a sequence of processing is executed as the subsequent processing of Steps S35 and after.

In other words, in Step S35, the image capture controller 51 determines whether or not the cumulative amount of angular displacement has reached a fixed value.

In a case of the cumulative amount of angular displacement not having reached the fixed value, it is determined as NO in Step S35, the processing is returned to Step S31, and this and following processing is repeated. In other words, the image capture controller 51 repeatedly executes the loop processing of Steps S31 to S35, unless the cumulative amount of angular displacement reaches the fixed value by the user causing the digital camera 1 to move by a fixed amount.

Thereafter, when the cumulative amount of angular displacement has reached the fixed value by the user causing the digital camera 1 to move by the fixed amount, it is determined as YES in Step S35, and the processing advances to Step S36.

In Step S36, the image capture controller 51 executes panoramic combination processing.

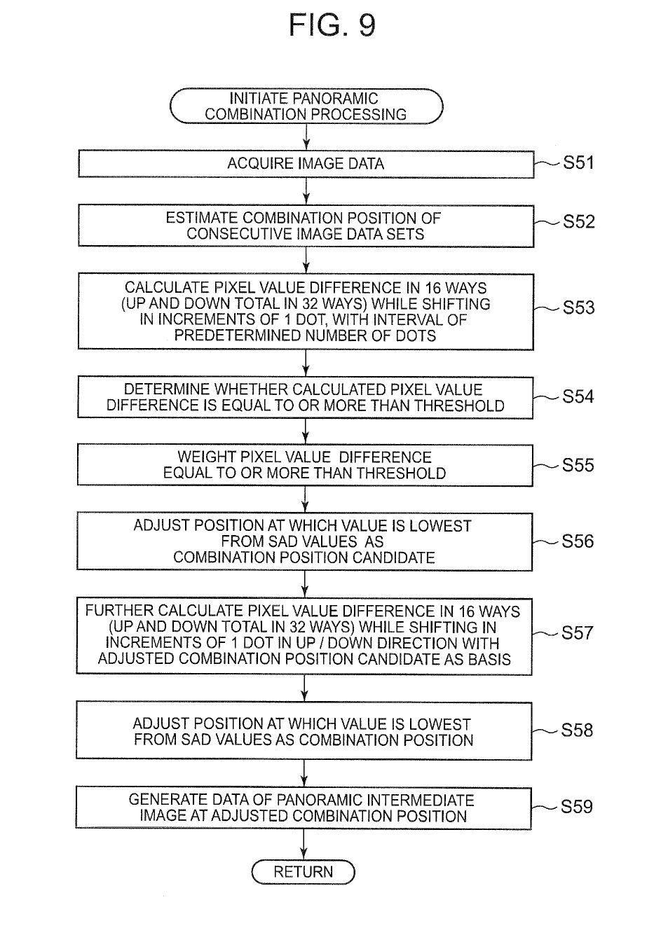

Although the details of panoramic combination processing are described later while referencing FIG. 9, image data (combination target) is acquired from the acquisition unit 52, and this image data is combined, thereby generating the image data of a panoramic intermediate image.

Panoramic intermediate image refers to an image showing regions captured thus far among a panoramic image planned for generation, in a case of a full press operation having been made while the panoramic photography mode is selected.

In Step S39, the image capture controller 51 updates the overall amount of angular displacement by adding the current cumulative amount of angular displacement (=roughly the fixed value) to the previous overall amount of angular displacement (updated overall amount of angular displacement=previous overall amount of angular displacement+cumulative amount of angular displacement). In other words, the value stored as the overall amount of angular displacement in the RAM 13 is updated.

In Step S40, the image capture controller 51 resets the cumulative amount of angular displacement to 0. In other words, the value stored as the cumulative amount of angular displacement in the RAM 13 is updated to 0.

The cumulative amount of angular displacement is used in this way for controlling the timing at which one set of image data (combination target) is supplied from the image processing unit 17 to the acquisition unit 52, i.e. issuance timing of acquisition command. Therefore, the cumulative amount of angular displacement is reset to 0 every time reaching a fixed amount and an acquisition command is issued.

Therefore, the image capture controller 51 cannot recognize to where the digital camera 1 has moved since the panoramic image capture processing was initiated until now, even if using the cumulative amount of angular displacement.

Therefore, in order to enable such recognition, the overall amount of angular displacement is employed apart from the cumulative amount of angular displacement in the present embodiment.

In other words, the overall amount of angular displacement is a value arrived at by cumulatively adding the amount of angular displacement; however, it is a value that is continually cumulatively added in a period until the panoramic image capture processing ends without being resent to 0 even if reaching a fixed amount (a period until the processing of Step S46 described later in detail is executed).

By configuring in this way, when the overall amount of angular displacement is updated in the processing of Step S39, and the cumulative amount of angular displacement is reset to 0 in the processing of Step S40, the processing advances to Step S41.

In Step S41, the image capture controller 51 determines whether or not a release operation has been performed.

In a case of a release operation not having been performed, i.e. in a case of full pressing of the shutter switch 41 by the user being continued, it is determined as NO in Step S41, and the processing advances to Step S42.

In Step S42, the image capture controller 51 determines whether or not error has occurred in image acquisition.

Although error in image acquisition is not particularly limited, in the present embodiment, an event of the digital camera 1 having moved equal to or more than a predetermined amount diagonally, in the up/down direction or the reverse direction is employed as error, for example.

In a case of error not having occurred in the image acquisition, it is determined as NO in Step S42, and the processing advances to Step S44.

In Step S44, the image capture controller 51 determines whether or not the overall amount of angular displacement has exceeded an angular displacement threshold.

As described in the foregoing, the overall amount of angular displacement is the cumulative additive value of the amount of angular displacement from the panoramic image capture processing being initiated (from the full pressing operation being made) until the moment when the processing of Step S44 is executed.

Herein, in the present embodiment, the maximum movement amount for which the user can make the digital camera 1 move during panoramic photography is set in advance. The overall amount of angular displacement corresponding to such a “maximum movement amount” as the movement amount of the digital camera 1 is provided beforehand as the “angular displacement threshold” by the initial setting processing of Step S1 in FIG. 7.

In this way, in the present embodiment, the event of the overall amount of angular displacement reaching the angular displacement threshold indicates that the digital camera 1 has moved by the maximum movement amount.

Therefore, in a case of the overall amount of angular displacement not reaching the angular displacement threshold, i.e. in a case of the movement amount of the digital camera 1 not reaching the maximum movement amount, the user can still continue to move the digital camera 1; therefore, it is determined as NO in Step S44, the processing is returned to Step S31, and this and following processing is repeated.

In other words, if the event of the continuation of the amount of angular displacement being 0 elapsing for a predetermined time (digital camera 1 not moving for a predetermined time) is included as one type of error, so long as the fully pressed operation is continued while no errors occur, the loop processing of Steps S31 to S44:NO will be repeatedly executed.

Thereafter, in a case of a release operation being made while no errors occur (determining as YES in the processing of Step S41), or the digital camera 1 moving by the maximum movement amount (determining as YES in the processing of Step S44), the processing advances to Step S45.

In Step S45, the image capture controller 51 generates the image data of a panoramic image through the acquisition unit 52, and causes to be recorded in the removable media 31 as the image data of a recording target.

It should be noted that, in the present embodiment, since the image data of a panoramic intermediate image is generated every time image data is acquired, the image data of the panoramic intermediate image generated at the moment of the processing of Step S45 is employed as the image data of a final panoramic image.

Then, in Step S46, the image capture controller 51 resets the overall amount of angular displacement to 0.

Panoramic photography processing thereby ends properly. In other words, the processing of Step S8 in FIG. 7 ends properly, and it is determined as NO in the subsequent processing of Step S9. It should be noted that, since the processing after having determined as NO in the processing of Step S9 is as described in the foregoing, an explanation thereof will be omitted here.

It should be noted that, in the case of any error occurring during the aforementioned sequence of processing, i.e. in a case of determining as YES in the processing of Step S33, or determining as YES in the processing of Step S42, the processing advances to Step S43.

In Step S43, the image capture controller 51 sets the error flag to 1.

In this case, the panoramic image capture processing ends improperly, without the processing of Step S45 being executed, i.e. without the image data of a panoramic image being recorded.

In other words, the processing of Step S8 in FIG. 7 ends improperly, it is determined as YES in the subsequent processing of Step S9, and the error contents are displayed in the processing of Step S10.

The display of error contents in this case are not particularly limited as described in the foregoing; however, a message display such as “image acquisition failed” or “timed out” can be used, for example.

The flow of panoramic image capture processing has been explained in the foregoing while referencing FIG. 8.

Next, the detailed flow of panoramic combination processing of Step S36 in the panoramic image capture processing of FIG. 8 will be explained while referencing FIG. 9.

FIG. 9 is a flowchart illustrating the detailed flow of panoramic combination processing.

As described in the foregoing, when the cumulative amount of angular displacement reaches a fixed value by the user causing the digital camera 1 to move a fixed amount, it is determined as YES in Step S35 of FIG. 8, the processing advances to Step S36, and the following such processing is executed as panoramic combination processing.

In other words, in Step S51 of FIG. 9, the acquisition unit 52 sequentially acquires, from the image processing unit 17, the image data of images consecutively captured under the control of the image capture unit 51.

In Step S52, for the respective image data sets acquired in Step S51, the estimation unit 53 estimates combination positions at which to combine in the combination portions of consecutive image data sets by way of the generation unit 58.

In Step S53, the calculation unit 54 calculates the pixel value differences in 16 ways (upper and lower total of 32 ways) while shifting in 1 dot increments in the up/down direction with an interval of a predetermined number of dots, with the combination position estimated in Step S52 as a basis.

In Step S54, the determination unit 55 determines whether or not the pixel value difference calculated in Step S53 is equal to or more than the threshold, and extracts a portion at which the pixel value difference is equal to or more than the threshold.

In Step S55, the weighting unit 56 calculates the weighted SAD of 32 ways weighted in the portion for which it was determined in Step S55 that the pixel value difference is equal to or more than the threshold.

In Step S56, the adjustment unit 57 adjusts, based on the weighted SAD values in the 32 ways calculated in Step S55, the position at which the value is lowest as a combination position candidate.

In Step S57, the calculation unit 54 further calculates the SAD in 16 ways (up and down total in 32 ways) while shifting in 1 dot increments in the up/down direction, with the combination position candidate adjusted in Step S56 as a basis.

In Step S58, the adjustment unit 57 adjusts, based on the SAD values in the 32 ways calculated in Step S57, the position way at which the value is lowest as the combination position.

In Step S59, the generation unit 58 combines the consecutive image data sets based on the combination position adjusted in Step S58 so as to generate the image data of a panoramic intermediate image, according to the control of the image capture controller 51.

The following operational effects are exerted according to the present embodiment.

With the digital camera 1 of the present embodiment, the acquisition unit 52 acquires consecutively captured images, and the generation unit 58 (combination unit) combines the image data sequentially acquired by the acquisition unit 52.

Then, for the respective data sequentially acquired by the acquisition unit 52, the estimation unit 53 estimates a combination position (a specific position) within the combination portions of consecutive image data sets (within a common region) by way of the generation unit 58, the calculation unit 54 calculates the pixel value difference (difference values) between image data sets within an overlapping region (within a common region), while shifting the specific position in a predetermined direction within the overlapping region (within a predetermined range of the common region), with the combination position (the specific position) estimated by the estimation unit 53 as a basis, and the weighting unit 56 calculates the weighted SAD based on the pixel value difference thus calculated (the difference values). The adjustment unit 57 adjusts so that the positions of image data sets at which the value of the weighted SAD within the overlapping region (within the common region) calculated by the weighting unit 56 becomes a minimum is the combination position (the specific position), and the generation unit 58 (the combination unit) combines consecutive image data sets based on the combination position (the specific position) adjusted by the adjustment unit 57 so as to generate the image data of a panoramic image.

In the combination of consecutive image data sets, it is thereby possible to estimate the combination position (the specific position) within the overlapping region of consecutive image data sets (within the common region), and then further, to adjust and combine at the combination position (the specific position) at which the weighted SAD value within the overlapping region (within the common region) is a minimum, i.e. at a combination position (a specific position) at which edge portions of image data in the consecutive image data sets are uniform.

Therefore, it is possible to improve the accuracy of alignment when combining images.

In addition, since the present embodiment is configured so that the estimation unit 53 estimates the combination position (the specific position) in advance, after which the calculation unit 54 calculates the value of the pixel value difference (the difference value) while shifting the image data by increments of a predetermined number of dots in the vertical direction, and then the adjustment unit 57 adjusts so that the position achieving the lowest SAD value becomes the combination position (the specific position), it is possible to lighten the processing load on the digital camera 1 more than by calculating the values of SAD and weighted SAD while shifting the image data in the vertical direction for all image data within the combination portion (within the common region), for example.

In addition, the determination unit 55 of the digital camera 1 of the present embodiment determines whether the pixel value difference (the difference value) calculated by the calculation unit 54 is equal to or more than a threshold, and if determined by the determination unit 55 that the pixel value difference (the difference value) is equal to or more than the threshold, the weighting unit 56 weights the pixel value difference (the difference value) to calculate a weighted SAD, and the adjustment unit 57 adjusts the combination position (the specific position) based on the weighted SAD calculated by the weighting unit 56.

Since it thereby becomes easier to set, from the candidates of combination positions (specific positions) at which the SAD value is lowest, a candidate of the combination position (the specific position) for which the pixel value difference (the difference value) is equal to or more than the threshold, i.e. for consecutive image data sets having the edge portion of the image data shifted, it becomes easier to adjust the combination position (the specific position) to a position at which the edge portions of image data are uniform. In addition, although not illustrated in FIG. 6, when converting the pixels of the combination portions (the common region) Fam, Fbm to luminance, even if noise occurs in this luminance, since it is configured so as to calculate the SAD value by weighting portions at which the pixel value difference (the difference value) (absolute value of difference in luminance between consecutive images) is equal to or more than a threshold, adjustment of the combination position is possible without being influenced by some noise during the conversion of luminance.

It should be noted that, although configured so as to adjust the combination position (the specific position) to a position at which the SAD is a minimum value, it is not limited thereto.

For example, it may be configured so as to adjust the combination position (the specific position) to a position at which the SAD value is a second value from the lowest value. By configuring in this way, adjustment of the combination position (the specific position) is possible taking account of the influence of some noise during the conversion of luminance.

In addition, the acquisition unit 52 of the digital camera 1 of the present embodiment acquires images sequentially captured by the imaging unit 16 every predetermined time period.

It is thereby possible to combine the image data sets acquired by sequentially adjusting the combination position (the specific position), while capturing images with the imaging unit 16.

It should be noted that the present invention is not to be limited to the aforementioned embodiment, and that modifications, improvements, etc. within a scope that can achieve the object of the present invention are also included in the present invention.

For example, although panoramic combination processing is performed during an imaging operation by the imaging unit 16 in the aforementioned embodiment, it is not particularly limited thereto, and the imaging operation by the imaging unit 16 may end, and then panoramic combination processing may be performed after all of the image data has been acquired for generating the image data of a panoramic image.

In addition, although established in a configuration that detects the amount of angular displacement of the digital camera 1 by way of the angular velocity sensor 22 in the aforementioned embodiment, the method of detecting the amount of angular displacement is not particularly limited thereto, and a method may be employed that analyzes a live-view image, and detects the amount of angular displacement of the digital camera 1 according to the motion vectors of images.

In addition, although the panoramic intermediate image and panoramic image are established in a landscape orientation configuration in the aforementioned embodiment, it is not particularly limited thereto, and it maybe established in a configuration that is long in a direction matching the movement direction of the digital camera 1, e.g., portrait orientation configuration, and so long as the generated image is a panoramic image, it will be sufficient to generate a wide-angle image having a wider angle of view than a single image by combining a plurality of images.

In addition, the image processing device to which the present invention is applied has been explained with an example configured as the digital camera 1 in the aforementioned embodiment.

However, the present invention is not particularly limited thereto, and can be applied to a general-purpose electronic devices having a function enabling the generation of a panoramic image, e.g., the present invention is widely applicable to portable personal computers, portable navigation devices, portable game devices, etc.

The aforementioned sequence of processing can be made to be executed by hardware, or can be made to be executed by software.

In the case of having the sequence of processing executed by way of software, a program constituting this software is installed from the Internet or a recording medium into the image processing device or a computer or the like controlling this image processing device. Herein, the computer may be a computer incorporating special-purpose hardware. Alternatively, the computer may be a computer capable of executing various functions by installing various programs, for example, a general-purpose personal computer.

The recording medium containing such a program is configured not only by the removable media 31 that is distributed separately from the main body of the device in order to provide the program to the user, but also is configured by a recording medium provided to the user in a state incorporated in the main body of the equipment in advance, or the like. The removable media 31 is configured by a magnetic disk (including a floppy disk), optical disk, magneto-optical disk, and the like, for example. The recording medium provided to the user in a state incorporated in the main body of the equipment in advance is configured by the ROM 12 in which the program is recorded, a hard disk included in the storage unit 18, or the like.

It should be noted that the steps describing the program recorded in the recording medium naturally include processing performed chronologically in the described order, but is not necessarily processed chronologically, and also includes processing executed in parallel or separately.

What is claimed is:

1. An image processing device, comprising:
an acquisition unit that acquires images;
an estimation unit that estimates a specific position within a common region between the images acquired by the acquisition unit;
a first calculation unit that sequentially calculates difference values between the images within the common region, while shifting the specific position estimated by the estimation unit in the predetermined direction within a predetermined range of the common region;
an adjustment unit that adjusts the specific position based on the difference values sequentially calculated by the first calculation unit; and
a combination unit that combines the images based on the specific position adjusted by the adjustment unit.

2. The image processing device according to claim 1, further comprising a second calculation unit that respectively calculates difference values between the images within the common region, while shifting the specific position adjusted by the first adjustment unit in the predetermined direction within a range narrower than the predetermined range,
wherein the adjustment unit further re-adjusts the specific position, based on the difference value calculated by the second calculation unit.

3. The image processing device according to claim 1, wherein the first calculation unit further respectively calculates the difference values between the images within the common region, while shifting the specific position by an increment of a predetermined number of dots within the predetermined range in an up/down direction as the predetermined direction.

4. The image processing device according to claim 1, wherein the second calculation unit further respectively calculates the difference values between the images within the predetermined region, while shifting the specific position by an increase of a number of dots that is less than the predetermined number of dots, in the up/down direction as the predetermined direction within a narrower range than the predetermined range.

5. The image processing device according to claim 1, further comprising:
a determination unit that determines whether the difference value calculated by the calculation unit is equal to or more than a threshold; and
a weighting unit that weights the difference value, if the determination unit determines that the difference value is equal to or more than the threshold by the calculation unit,
wherein the adjustment unit adjusts the specific position, based on the difference value weighted by the weighting unit.

6. The image processing device according to claim 1, wherein the adjustment unit adjusts the specific position to a position at which the difference value calculated by the first calculation unit is a minimum.

7. The image processing device according to claim 1, wherein the combination unit generates a panoramic image by combining the images.

8. The image processing device according to claim 1, wherein the first calculation unit calculates one of the difference values each time the specific position is shifted by a predetermined amount in the predetermined direction within the predetermined range of the common region

9. The image processing device according to claim 1, wherein the first calculation unit sequentially calculates difference values, while shifting the specific position such that the common region is changed.

10. The image processing device according to claim 1, further comprising an imaging unit,
wherein the acquisition unit acquires images sequentially captured by the imaging unit every predetermined time period.

11. An image processing method comprising the steps of:
acquiring images;
estimating a specific position within a common region between the images acquired by the acquisition unit;
sequentially calculating difference values between the images within the common region, while shifting the specific position estimated in the step of estimating in the predetermined direction within a predetermined range of the common region;
adjusting the specific position based on the difference values between the images sequentially calculated in the step of calculating; and
combining the images based on the specific position adjusted in the step of adjusting.

12. A recording medium encoded with a computer readable program for enabling a computer to function as:
an acquisition unit that acquires images;
an estimation unit that estimates a specific position within a common region between the images acquired by the acquisition unit;
a calculation unit that sequentially calculates difference values between the images within the common region, while shifting the specific position estimated in the step of estimating in the predetermined direction within a predetermined range of the common region;
an adjustment unit that adjusts the specific position based on the difference values between the images respectively calculated in the step of calculating; and
a combination unit that combines the images based on the specific position adjusted in the step of adjusting.
